(19) United States
(12) Patent Application Publication
(10) Pub. No.: US 2020/0203046 A1
(43) Pub. Date: Jun. 25, 2020

(54) NANOFIBER SHEET HOLDER

(71) Applicant: Lintec of America, Inc., Richardson, TX (US)

(72) Inventors: Chi Huynh, Richardson, TX (US); Jaeah Lee, Richardson, TX (US); Raquel Ovalle-Robles, Richardson, TX (US)

(73) Assignee: Lintec of America, Inc., Richardson, TX (US)

(21) Appl. No.: 16/804,704

(22) Filed: Feb. 28, 2020

Related U.S. Application Data
(63) Continuation of application No. PCT/US18/60042, filed on Nov. 9, 2018.
(60) Provisional application No. 62/586,325, filed on Nov. 15, 2017.

(51) Int. Cl. H01F 1/00; C08K 7/02; B25B 11/00; B82Y 30/00

(52) U.S. Cl. CPC H01F 1/0081; B82Y 30/00; B25B 11/002; C08K 7/02

(57) ABSTRACT

Holders for nanofiber sheets that can reduce the probability of damage to a nanofiber sheet during transport, handling, or experimental preparation are described. These holders can improve the convenience with which nanofiber sheets can be manipulated. Holders generally include two features: an outer case and a clamp disposed within the outer case. The clamp, which can be embodied in any of a variety of ways, mounts to a peripheral edge at one or more locations on the nanofiber sheet. The nanofiber sheet is held fixed in place within the outer case and is suspended within the chamber defined by the outer case and the client.

### RELATED APPLICATIONS

This application is a continuation application under 35 U.S.C. § 111(a) of PCT Application No. PCT/US18/60042, filed on Nov. 9, 2018, which claims priority under 35 USC § 119(e) to U.S. Provisional Patent Application No. 62/586,325 entitled “Nanofiber Sheet Holder,” filed on Nov. 15, 2017, both of which are incorporated by reference herein in their entirety.

### TECHNICAL FIELD

The present disclosure relates generally to nanofiber sheets. Specifically, the present disclosure relates to nanofiber sheet holders.

### BACKGROUND

Nanofiber forests, composed of both single wall and multiwalled nanotubes, can be drawn into nanofiber ribbons or sheets. In its pre-drawn state, the nanofiber forest comprises a layer (or several stacked layers) of nanofibers that are parallel to one another and perpendicular to a surface of a growth substrate. When drawn into a nanofiber sheet, the orientation of the nanofibers changes from perpendicular to parallel relative to the surface of the growth substrate. The nanotubes in the drawn nanofiber sheet connect to one another in an end-to-end configuration to form a continuous sheet in which a longitudinal axis of the nanofibers is parallel to a plane of the sheet (i.e., parallel to both of the first and second major surfaces of the nanofiber sheet). Individual nanofiber sheets can be from a few microns thick to tens of nanometers thick.

### SUMMARY

Example 1 is a nanofiber sheet holder comprising: a first portion comprising: a first body, an interior surface of the first body defining a first chamber; a rim on the interior surface of the first body, the rim proximate to at least a portion of a perimeter of the first chamber; a second portion comprising: a second body, an interior surface of the second body defining a second chamber; a support on the interior surface of the second body, the support proximate to at least a portion of a perimeter of the second chamber; a nanofiber sheet in contact with at least one of the rim of the first portion and the support of the second portion; wherein: the first portion and the second portion are configured to mount together at a joint; and the rim and the support are configured to align with each other when the first portion and the second portion are mounted together, thus clamping a peripheral edge of the nanofiber sheet therebetween.

Example 2 includes the subject matter of Example 1, further comprising a conductive layer on at least one of the interior surface of the first body, the interior surface of the second body, the rim, and the support.

Example 3 includes the subject matter of either of Example 1 or Example 2, wherein the rim and the support are configured to contact one another without the nanofiber sheet therebetween when the first portion and the second portion are mounted together.

Example 4 includes the subject matter of Example 3, wherein contact between the rim and the support without the nanofiber sheet therebetween comprises an interference fit.

Example 5 includes the subject matter of Example 3, further comprising a freestanding portion of the nanofiber sheet within the peripheral edge, the freestanding portion supporting its own weight within the nanofiber sheet holder when the peripheral edge is clamped between the rim and the support.

Example 6 includes the subject matter of Example 5, wherein the first chamber and the second chamber form a combined chamber when the first portion and the second portion are mounted together, the freestanding portion of the nanofiber sheet disposed within the combined chamber.

Example 7 includes the subject matter of any of the preceding Examples, wherein the rim and the support are integral with the first portion and the second portion, respectively.

Example 8 includes the subject matter of any of the preceding Examples, wherein the rim and the support are continuous around the perimeter of the first chamber and the perimeter of the second chamber, respectively.

Example 9 includes the subject matter of Example 8, wherein the rim and the support together comprise a removable frame that can be removed from at least one of the first body and the second body.

Example 10 includes the subject matter of Example 9, wherein the rim and the support are configured to contact one another without the nanofiber sheet therebetween when the first portion and the second portion are mounted together.

Example 11 includes the subject matter of Example 10, wherein the contact between the rim and the support comprises an interference fit.

Example 12 includes the subject matter of Example 10, further comprising a freestanding portion of the nanofiber sheet within the peripheral edge, the freestanding portion supporting its own weight within the nanofiber sheet holder when the peripheral edge is clamped between the rim and the support.

Example 13 includes the subject matter of Example 12, wherein the removable frame and the nanofiber sheet are removable as a unit from the first portion and the second portion.

Example 14 is a nanofiber sheet holder comprising: a first portion comprising: a first body, an interior surface of the first body defining a first chamber; a first spacer on the interior surface of the first body, the first spacer proximate to at least a portion of a perimeter of the first chamber; a second portion comprising: a second body, an interior surface of the second body defining a second chamber; a second spacer on the interior surface of the second body, the second spacer proximate to at least a portion of a perimeter of the second chamber; and a nanofiber sheet in contact with at least one of the first spacer and the second spacer, wherein the first portion and the second portion are configured to mount together at a joint.

Example 15 includes the subject matter of Example 14, wherein a distance between the first spacer and the second spacer when the first portion and the second portion are mounted together is configured to secure a substrate in contact with the nanofiber sheet.

Example 16 includes the subject matter of Example 15, wherein the distance between the first spacer and the second spacer is from 0.2 mm to 10 mm.

Example 17 includes the subject matter of any of Examples 14-16, wherein the second portion further defines a third chamber in communication with the second chamber, the third chamber having a depth of from 0.2 mm to 10 mm at an intersection with the second chamber.

Example 18 includes the subject matter of any of Examples 14-17, wherein the first spacer and the second spacer are O-rings.

Example 18 includes the subject matter of Example 18, wherein the O-rings are silicone rubber.

Example 20 is a nanofiber sheet holder comprising: first portion comprising a first body, an interior surface of the first body defining a first chamber; a second portion comprising: a second body, an interior surface of the second body defining a second chamber; a magnet connected to the interior surface of the second body within the second chamber; and a nanofiber sheet on the magnet, the nanofiber sheet comprising a magnetic material, wherein the first portion and the second portion are configured to mount together at a joint.

Example 21 includes the subject matter of Example 20, wherein the nanofiber sheet further includes a layer of metal between the magnetic material and nanofibers of the nanofiber sheet.

Example 22 includes the subject matter of either of Examples 20 or 21, wherein the magnetic material on the nanofiber sheet is iron.

Example 23 includes the subject matter of any of Examples 20-22, further comprising a substrate between the nanofiber sheet and the magnet.

Example 24 includes the subject matter of any of Examples 20-23, further comprising a frame within the second chamber configured to support at least a portion of the nanofiber sheet on the magnet.

Example 25 is an apparatus comprising: a nanofiber structure comprising a ferromagnetic material; a housing; and a magnet positioned in the housing, wherein the nanofiber structure is held in position with reference to the housing by a magnetic field.

Example 26 includes the subject matter of Example 25, wherein the nanofiber structure is selected from at least one of sheets, ribbons and yarns.

Example 27 includes the subject matter of either of Examples 25 or 26, wherein the nanofiber structure is in contact with the magnet.

Example 28 includes the subject matter of any of Examples 25-27, wherein the magnet is a permanent magnet or an electromagnet.

Example 29 includes the subject matter of Example 28, wherein a shape of the magnet is selected from circular, cylindrical, rectangular, a ring or toroidal.

Example 30 includes the subject matter of Example 28, wherein the magnet includes a surface that is planar, concave or convex.

Example 31 includes the subject matter of any of Examples 25-30, further comprising a substrate positioned between the nanofiber structure and the magnet.

Example 32 includes the subject matter of any of Examples 25-31, wherein only a portion of the nanofiber structure comprises a ferromagnetic material.

Example 33 includes the subject matter of any of Examples 25-32, wherein the nanofiber structure includes the ferromagnetic material on a surface facing the magnet, a surface facing away from the magnet, or on both surfaces.

Example 34 is a method for securing a nanofiber sheet comprising: clamping a nanofiber sheet between a first portion of a clamp and a second portion of the clamp by placing a first portion and a second portion in contact with at least some of a peripheral edge of the nanofiber sheet; and enclosing the nanofiber sheet, the first portion of the clamp, and the second portion of the clamp within a nanofiber sheet holder, the nanofiber sheet holder separating the nanofiber sheet from an environment surrounding the nanofiber sheet holder, wherein a freestanding portion of the nanofiber sheet not positioned between the first portion and second portion is suspended within a chamber defined by an interior surface of the nanofiber sheet holder.

Example 35 includes the subject matter of Example 34, t wherein he freestanding portion of the nanofiber sheet supports its own weight.

Example 36 includes the subject matter of either of Examples 34-35, wherein the first portion of the clamp and the second portion of the clamp are configured to contact one another without the nanofiber sheet therebetween when enclosed within the nanofiber sheet holder.

Example 37 includes the subject matter of Example 36, wherein the contact between the first portion and the second portion of the clamp is an interference fit, that clamps a nanofiber sheet less than 300 microns thick therebetween.

Example 38 includes the subject matter of Example 37, wherein the interference fit clamps a peripheral edge of the nanofiber sheet between the first portion and the second portion, the nanofiber sheet less than 300 microns thick.

Example 39 includes the subject matter of any of Examples 34-38, wherein: the first portion and the second portion of the clamp are integral with the nanofiber sheet holder; and clamping the nanofiber sheet contemporaneously includes enclosing the nanofiber sheet within the nanofiber sheet holder.

Example 40 includes the subject matter of any of Examples 34-39, further comprising electrically grounding an interior of the nanofiber sheet holder via a conductive layer disposed on the interior surface of the nanofiber sheet holder.

Example 41 includes the subject matter of any of Examples 34-40, wherein the first portion and the second portion of the clamp are placed in contact with an entire peripheral edge of the nanofiber sheet.

Example 42 includes the subject matter of any of Examples 34-21, wherein the first portion and the second portion of the clamp are placed in contact with at least two discontinuous portions of the peripheral edge of the nanofiber sheet.

Example 43 is a method for securing a nanofiber sheet comprising: providing a magnetic material to the nanofiber sheet, thereby forming a magnetic nanofiber sheet; placing the magnetic nanofiber sheet on a magnet fixed to an interior of a second portion of a housing; and placing a first portion of the housing on the second portion.

Example 44 includes the subject matter of Example 43, wherein the providing comprises depositing a layer of a magnetic material on the nanofiber sheet to form the magnetic nanofiber sheet.

Example 45 includes the subject matter of Example 44, further comprising depositing a layer of metal in direct contact with the nanofiber sheet prior to depositing the layer of magnetic material.

Example 46 includes the subject matter of any of Examples 43-45, wherein the providing comprises infiltrating particles of a magnetic material into the nanofiber sheet.

Example 47 includes the subject matter of any of Examples 43-46, further comprising placing the magnetic nanofiber sheet on a substrate before the placing on the magnet.

Example 48 includes the subject matter of any of Examples 43-47, wherein the magnetic material is iron.

Example 49 includes the subject matter of any of Examples 43-48, further comprising placing a frame in the interior of the second portion of the housing between the magnet and an interior surface of the second portion.

Example 50 includes the subject matter of Example 49, wherein the frame is configured to support a portion of the nanofiber sheet not on the magnet.

Example 51 includes the subject matter of any of Examples 43-50, wherein the magnetic nanofiber sheet is in direct contact with the magnet.

### BRIEF DESCRIPTION OF THE DRAWINGS

FIG. 1 is a cross-sectional view of a nanofiber sheet holder of the present disclosure taken at a location indicated in FIG. 2, in an embodiment.

FIG. 2 is a plan view of the nanofiber sheet holder shown in FIG. 1, in an embodiment.

FIGS. 3 and 4 are cross-sectional views of the nanofiber sheet holder taken at locations indicated in FIG. 2, in embodiments.

FIGS. 5-8 are cross-sectional and plan views of a nanofiber sheet holder configured to hold at least one nanofiber sheet on a substrate, in embodiments of the present disclosure.

FIGS. 9-13D depict various views of an example sample holder configured to include a removable frame configured to hold a nanofiber sheet within the sample holder, in embodiments.

FIG. 14 is a plan view of a nanofiber sheet holder that includes a magnetic, in an embodiment of the present disclosure.

FIG. 15 is a cross-sectional view of a nanofiber sheet holder that includes a magnetic, in an embodiment of the present disclosure.

FIG. 16 illustrates an example forest of nanofibers on a substrate, in an embodiment.

FIG. 17 illustrates an example reactor used for growing nanofibers, in an embodiment.

FIG. 18 is an illustration of a nanofiber sheet that identifies relative dimensions of the sheet and schematically illustrates nanofibers within the sheet aligned end-to-end in a plane parallel to a surface of the sheet, in an embodiment.

FIG. 19 is an image of a nanofiber sheet being laterally drawn from a nanofiber forest, the nanofibers aligning from end-to-end as schematically.

The figures depict various embodiments of the present disclosure for purposes of illustration only. Numerous variations, configurations, and other embodiments will be apparent from the following detailed discussion. Furthermore, as will be appreciated, the figures are not necessarily drawn to scale or intended to limit the described embodiments to the specific configurations shown. For instance, while some figures generally indicate straight lines, right angles, and smooth surfaces, an actual implementation of the disclosed techniques may have less than perfect straight lines and right angles, and some features may have surface topography or otherwise be non-smooth, given real-world limitations of fabrication processes. In short, the figures are provided merely to show example structures.

### DETAILED DESCRIPTION

### Overview

Nanofiber sheets have a variety of technological applications due to their novel mechanical, thermal, and electrical properties (and combinations of these properties). Recent advances have made the production of nanofiber sheets more convenient, economical, and consistent. Because of the improved economics and manufacturing consistency, the interest in nanofiber sheets continues to grow.

However, nanofiber sheets can be fragile. In some cases, when drawn from a nanofiber forest, the as-drawn sheet can be, for example, approximately from 50 μm thick to 200 μm thick. When the nanofiber sheet has been treated with a liquid that includes a volatile component (e.g., a solvent or a polymer in a solvent), physical dimensions of the nanofiber sheet, in particular a thickness, can be reduced upon removal of the volatile component. This process—often referred to as “densification”—can reduce a nanofiber sheet thickness by as much as a factor of 1000 and/or produce a densified nanofiber sheet as thin as tens of nanometers.

Regardless of whether the sheet is densified or not densified, nanofiber sheets can be quite fragile. Any of a variety of mechanical perturbations, even those as slight as air currents from air handling equipment or the movement of a door, can cause a nanofiber sheet to tear, wrinkle, or to become entangled and/or adhered to itself. Any of these types of damage are likely to render the nanofiber sheet unusable. This has the effect of making additional technological development involving nanofiber sheets more difficult because samples can be damaged during transit or during preparation for an experiment. Any type of damage to a sheet increases the cost and inconvenience of using nanofiber sheets. Furthermore, a nanofiber sheet will often cling to itself or to any structure that comes into contact with the nanofiber sheet. Separating the nanofiber sheet often leaves the nanofiber sheet damaged (e.g., torn or wrinkled) in a way that reduces its mechanical, thermal, and electrical properties.

Thus, and in accordance with an embodiment of the present disclosure, embodiments of holders for nanofiber sheets are described. The example holders described herein can reduce the probability of damage to a nanofiber sheet during, for example, transport, handling, or experimental preparation. For at least this reason, embodiments described herein can improve the convenience with which nanofiber sheets can be manipulated.

Example holders of the present disclosure generally include two features. The first feature is an outer case. The outer case provides a mechanically durable shelter for a nanofiber sheet disposed therein. The outer case can prevent the nanofiber sheet from being damaged through routine handling, shipment, air currents, other physical perturbations, as well as from contamination. In some examples the outer case is closed and secured, and/or (hermetically) sealed. Sealing in particular can help to prevent or reduce the movement of air over the sheet, thus reducing the likelihood of forces or contaminants exterior to the holder from affecting the nanofiber sheet therein.

The second feature of the example holders of the present disclosure is a clamp disposed within the outer case that is configured to suspend a nanofiber sheet (and in some embodiments also a substrate) within a chamber defined by interior surfaces of the holder (and more specifically, interior surfaces of the outer case). Elements of example clamps described herein, which can be embodied in any of a variety of ways as described below, mount to a peripheral edge at one or more locations on the nanofiber sheet. In this way, the nanofiber sheet is held fixed in place within the outer case and is suspended within a chamber defined by interior surfaces of the outer case. Configuring the holder so as to suspend a nanofiber sheet within the chamber, and thus maintain a separation between the nanofiber sheet and interior surfaces of the outer case, enables the nanofiber sheet to flex and move within a natural range of motion (e.g., from the elasticity of the material of the sheet, and the flexibility of the sheet itself) without contacting the interior surfaces of the outer case. In some embodiments, a clamp that is removable from the outer case (e.g., a frame that is a separate structure disposed within the frame and configured to hold a nanofiber sheet and/or a substrate) can be stabilized by applying pressure to the frame (e.g., from a tool, a finger, a weight) while portions of the outer case is being removed. A removable clamp or frame that is used to stabilize the nanofiber sheet can also be used to move the nanofiber sheet with a reduced risk of damage even without the outer case. This can be due, in part, to the clamping of a peripheral edge of the nanofiber sheet, which reduces the likelihood of bundling.

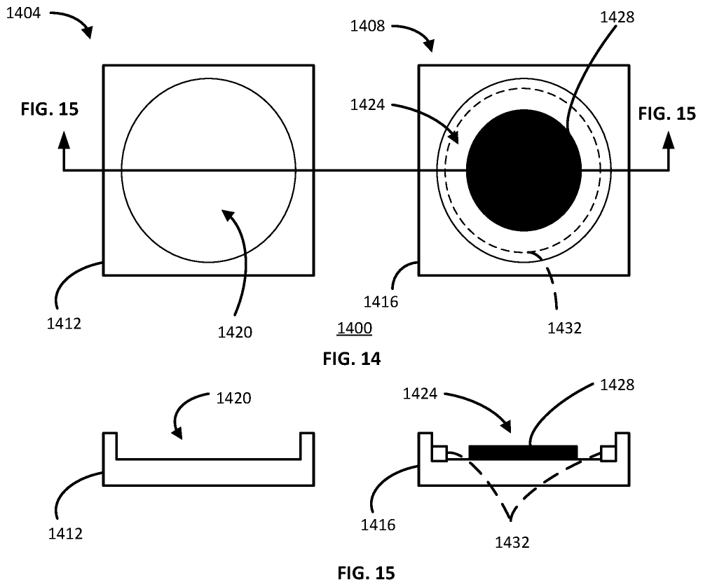

A description of nanofibers, nanofiber processing, and nanofiber sheets follows the description of the nanofiber sheet holder. These are described in the context of FIGS. 14-17.

### Nanofiber Sheet Holder

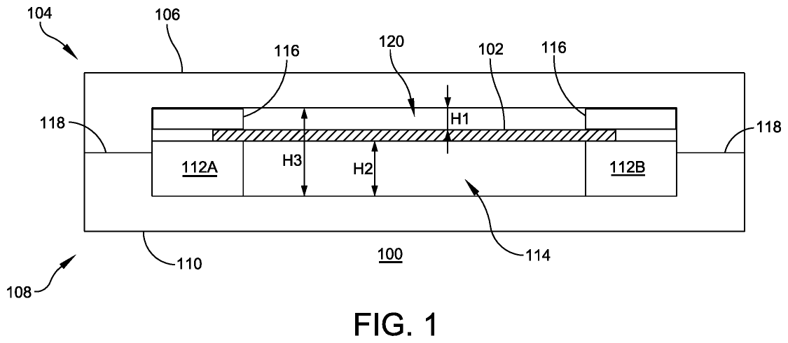

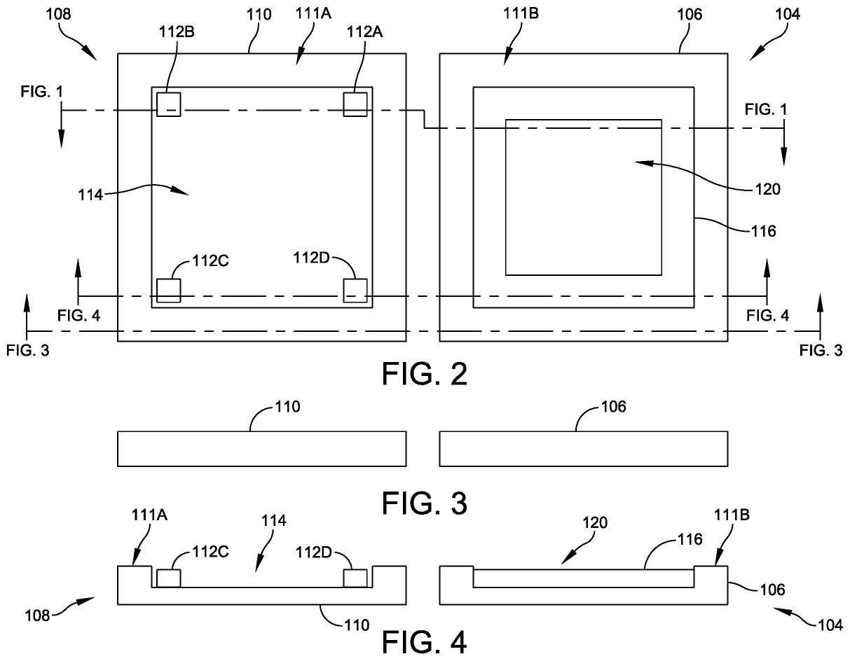

FIG. 1 illustrates a cross-sectional view (the location of which is indicated in FIG. 2) of one example holder 100 of the present disclosure. The holder 100 includes a first portion 104 and a second portion 108, which define the outer case mentioned above. At a high level, the first portion 104 includes a body 106 that defines a first chamber 120, a first rim 116. The second portion 108 includes a body 110 that defines a second camber 114, supports 112A-112D.

The first portion 104 and the second portion 108 are configured to connect or mount to one another via confronting surfaces 111A and 111B (shown in FIGS. 2 and 4), thus securing a nanofiber sheet 102 therein and protecting the nanofiber sheet 102 from damage. These confronting surfaces 111A and 111B form a joint 118 when in contact with one another. The joint 118 can then be mechanically locked (e.g., via an interlocking mechanism, exterior clamp, screw) and/or hermetically sealed. This connection, whether hermetic or not, can protect the nanofiber sheet 102 from damage from air currents or from contamination from ambient environments. Examples of contaminants include chemicals that would degrade the properties of the nanofiber sheet. While not shown, it will be appreciated that a hermetic seal between the first portion 104 and the second portion 108 can be facilitated by sealing agents including, but not limited to, an O-ring disposed at the joint 118, adhesives at the joint 118, or other sealant (e.g., silicone/vacuum grease, thermoplastic polymer, solder) applied within the joint 118 or on an exterior surface of the holder 100 that covers at least an exterior edge of the joint 118.

Furthermore, when the first portion 104 and the second portion 108 are connected or mounted to one another, the two portions define a chamber within which the nanofiber sheet 102 can be disposed. For convenience of explanation, this chamber is described as comprising the first chamber 120 defined by the first portion 104 and the second chamber 114 defined by the second portion 108. These two chambers 120, 114 are separated from one another when the nanofiber sheet 102 is disposed within a closed holder 100. The second chamber 114 and the first chamber 120 are configured so that the distances H1 and H2 are greater than any flexure and or elasticity exhibited by the nanofiber sheet 102. Dimensioning the second chamber 114 and the first chamber 120 in this way (and in coordination with rim 116 and supports 112A and 112B (collectively or generically 112), which are described below in more detail) thus prevents the nanofiber sheet 102 from contacting inner surfaces of the first portion 104 and the second portion 108 that define their corresponding chambers. This may reduce the likelihood of damage to the nanofiber sheet 102 caused by contact with an interior or the holder 100 itself. The distances H1 and H2 can be, individually, within any of the following ranges; 0.1 mm to 5 mm; 1 mm to 10 mm; 1 mm to 5 mm; 5 mm to 10 mm; 1 mm to 3 mm; 3 mm to 7 mm; 0.1 mm to 1 mm; 0.5 mm to 1 mm. The distance H3 is equal to or slightly greater than the sum of H and H2. In some examples the distance H3 can be within any of the following ranges: 0.2 mm to 12 mm; 2 mm to 22 mm; 2 mm to 15 mm; 10 mm to 25 mm 2 mm to 8 mm; 6 mm to 15 mm; 0.2 mm to 4 mm; 0.5 mm to 3 mm. The distance H3 is dimensioned so that the rim 116 and the supports 112 form an interference fit with an intervening nanofiber sheet 102 (and optionally a substrate on which a nanofiber sheet is disposed). The difference between the distance H3 and the sum of the distances H1 and H2 can be within any of the following ranges: 1 mm to 2 mm; 25 μm to 1 mm; 0 μm to 75 μm. In one example, because nanofiber sheets can be as thin as tens of nanometers (or even less), the distances H1, H2, and H3 are configured so that the rim 116 and supports 112 can contact one another, and thus form a clamp that secures a nanofiber sheet therebetween when the nanofiber sheet has a thickness that is less than manufacturing tolerances for these various components.

Turning to the individual components of the holder 100 in more detail, the first portion 104 of the holder 100 includes the first body 106 and a rim 116. The second portion 108 of the holder 100 includes a second body 110 and supports 112A, 112B, 112C, and 112D (collectively and generically 112).

The first body 106 and the second body 110 can be fabricated from any convenient material including, but not limited to, polycarbonate, thermoplastic polymers, thermosetting polymers, epoxide polymers, metals, ceramics, and combinations thereof. The first portion 104 can be fabricated using molding (e.g., blow molding, injection molding), subtractive fabrication techniques (e.g., using machine tools to remove material from a uniform block of starting material), and additive fabrication techniques (e.g., “3D printing”).

Connected to, or integral with, the first body 106 is the rim 116. The rim 116 is designed and configured to form an interference fit with the nanofiber sheet 102 and the supports 112 (only two of which. 112A and 112B are shown in the view in FIG. 1) of the second portion 108 when the first portion 104 and the second portion 108 are connected or mounted to one another. Because the nanofiber sheet 102 can have dimensions that range generally from a few hundred microns to tens of nanometers, the rim 116 can be configured to contact the supports 112 so as to impinge on the nanofiber sheet 102. This generally will provide sufficient force to secure the nanofiber sheet 102 during movement of holder 100. As indicated above in the context of dimensions H1, H2, and H3, the rim 116 and the supports 112 can be dimensioned and configured to accommodate a substrate on which one or more nanofiber sheets is disposed.

The rim 116 can be fabricated from any of the materials and using any of the techniques described above, even if the materials and techniques used to fabricate the rim 116 are different from those used to fabricate a corresponding first body 106.

The rim 116 can conform to some or all of a perimeter of the first chamber 120 defined by an interior surface of the first body 106. In the case of the example holder 100 illustrated in FIG. 1, the rim 116 corresponds to an entire perimeter of the first chamber 120 (as shown in FIG. 2). However, in other embodiments the rim 116 can correspond to any two opposing sides of a square chamber, correspond to small portions of the perimeter, or correspond to other portions (in whole or in part) of a perimeter of a chamber of any shape. Regardless of whether the rim 116 is continuous around a perimeter or is composed of separate and discrete portions, the rim 116 (or rim segments) is situated so as to contact corresponding supports 112.

As indicated above, supports 112 (two of which are shown in the cross-section of FIG. 1, and four of which are shown in the plan view of FIG. 2) perform an analogous function to that performed by the rim 116. That is, the supports 112 are disposed on an interior surface of the second body 110 so as to align with and contact the rim 116 when the first portion 104 and the second portion 108 are mounted together. This contact can be used to suspend the nanofiber sheet 102 within combined chambers 114, 120 defined by the first portion 104 and the second portion 108. As described above for the rim 116, supports 112 can be configured to form an interference fit and/or to contact the rim 116, thus impinging a peripheral edge of the nanofiber sheet 102 and suspending a freestanding portion of the nanofiber sheet 102 within the combined chamber.

In one embodiment, the holder 100 can include a conductive liner on interior surfaces of the chambers 114 and 120. That is, the conductive liner covers the exposed surfaces of rim 116, supports 112A and 112B (and other supports not shown in this view), and any exposed interior surfaces of the body 106 or the body 110. The conductive liner can help prevent or reduce the collection of electrical charge on the surfaces of the holder 100 thus preventing or reducing the likelihood of electrostatic discharge that could damage the nanofiber sheet 102. The conductive liner also reduces the likelihood of the accumulation of static electricity that could cause the nanofiber sheet to cling to itself, the holder 100, or some other structure.

FIG. 2 illustrates a plan view of the first portion 104 and the second portion 108. The lines of cross-section for FIG. 1, FIG. 3, and FIG. 4 are indicated in FIG. 2. FIG. 2 includes many of the same elements shown in cross-section in FIG. 1 and described above. As can be appreciated in these plan views, the second portion 108 includes four supports 112A, 112B, 112C, 112D (collectively, supports 112). Similarly, the first portion 104 includes the rim 116 that corresponds to a square that defines the entire perimeter of the chamber 120. As mentioned above, these example embodiments are merely for convenience of description. In other embodiments different configurations of supports 112 and rim 116 are possible without departing from the scope of the present disclosure.

The cross-section shown in FIG. 3 is taken at an outer edge of the body 110 of the second portion 108 and the body 106 of the first portion 104. The surfaces shown in FIG. 3, and their analogues around the exterior perimeter of the first portion 104 and the second portion 108 confront one another at the confronting surfaces 111A. 111B to form the joint 118. As mentioned above, the surfaces can be sealed using a gasket, O-ring, solder, a thermoplastic of thermosetting polymer or other sealant that can prevent the flow of gas or particles to and from the interior of the holder 100. This prevents mechanical perturbation or contamination of the nanofiber sheet 102 caused by the infiltration (or flow) of gas to and/or from an interior of the holder 100.

FIG. 4 is a cross-sectional view of the holder 100 taken through supports 112C and 112D and through the rim 116. FIG. 4 shows in cross-section the definition of the chambers 114 and 120 by their corresponding bodies 110, 106. The cross-section of FIG. 4 also illustrates the differences between the supports 112 and the rim 116. As described above, in the example embodiment holder 100, the supports 112 are shown as discrete square or rectangular structures disposed at the corners of the second portion 108 and the rim 116 is shown as a rectangular cross-section structure that corresponds to the perimeter of the chamber 120. As also indicated above, these shapes and configurations are merely presented for convenience of explanation and many other variations are possible.

In some embodiments, the supports 112 may be discrete (as shown) or continuous (e.g., a unitary structure that conforms to the perimeter of the first chamber 120). Similarly, in some embodiments the rim 116 may discrete (i.e., analogous to the supports 112 shown in FIGS. 1, 2, and 4) or continuous (as shown in FIG. 2). In still other embodiments, it will be appreciated that the supports 112 and the rim 116 may have any configuration as long as they form an interference fit with an intervening nanofiber sheet 102. The interference fit, as described above, secures and physically stabilizes the nanofiber sheet 102 so that it becomes more resistant to wrinkling, tearing, or adhering to itself or an interior surface of the holder 100. However, it will be appreciated that having at least one of the supports 112 and the rim 116 configured with discrete portions (i.e., not a continuous structure corresponding to an entire perimeter of a corresponding chamber) can facilitate removal of the nanofiber sheet by reducing the area of contact between the nanofiber sheet and the structures that suspend the nanofiber sheet in the chamber.

Supports 112 and the rim 116 can be fabricated from acrylic polymers, fluorinated polymers, polyethylene, metals coated with any of the preceding polymers, ceramics, and combinations thereof. Also, as indicated above, the supports 112 and/or the rim 116 can be coated with a thin film of a conductive material to reduce the accumulation of static electricity, thus reducing the risk of ESD and clinging of the nanofiber sheet 102 to proximate surfaces caused by the static electricity attraction.

While not shown, it will be appreciated that other features can be integrated into the first body 106 and the second body 110. For example, a hinge can be connected to the first body 106 and the second body 110 to improve the convenience with which the holder 100 can be opened and closed. In another example, connectable interlocking features can be integrated into the first body 106 and the second body 110 so that the two can be releasably and firmly secured together. In still another example, the first body 106 and the second body 110 can define pinholes or screw holes that can be used to secure the first body 106 the second body 110 together.

In still another embodiment, the holder 100 can be placed in communication with a vacuum prior to sealing so as to remove any air or ambient atmosphere disposed within the chambers 114 and 120. This can help remove impurities (e.g., contaminant gases, particulates) so as to maintain the purity of the nanofiber sheet 102. During or after the exposure of the holder 100 to a vacuum, the joint 118 can be sealed as described above to prevent infiltration of contaminants and/or ambient atmosphere. Alternatively, after exposing the holder 100 to the vacuum, an inert atmosphere (e.g., nitrogen, argon) can be provided so as to fill the chambers 114 and 120 within an unreactive (“inert”) and/or purified atmosphere lacking in particulate contaminants or other contaminants. The joint 118 can then be sealed as described above to preserve this unreactive and purified atmosphere. Either of these changes of atmosphere (i.e., to vacuum or an inert atmosphere) can also reduce the likelihood of the nanofiber sheet 102 from wrinkling, tearing, or forming bundles of locally aggregated nanofibers that create gaps in the sheet.

In still yet another embodiment the joint 118 can be formed at surfaces 111A. 111B that include crenellated surfaces that interlock, thus forming a box joint. This can increase the surface area of the joint 118, which can improve the mechanical durability of the seal at the joint 118 as well as increasing the resistance of the joint 118 to air and or contaminant infiltration.

### Nanofiber Sheet and Substrate Holder

In some embodiments, a nanofiber sheet to be placed within the holder is disposed on one or both sides of a substrate. In embodiments, the substrate can be a metal, a polymer, a ceramic, or a composite. In this case, the holder 100 can be configured so as to form an interference fit with both the substrate and the nanofiber sheet disposed on the substrate. That is, the supports 112 and the rim 116, as well as the sizes of the chambers 114 and 120 (e.g., analogs to H1, H2, and H3 described above), can be configured and dimensioned as described above so that the supports 112 and the rim 116 impinge on the substrate and any nanofiber sheets disposed thereon. This secures the nanofiber sheet (and the substrate) within the holder, as previously described.

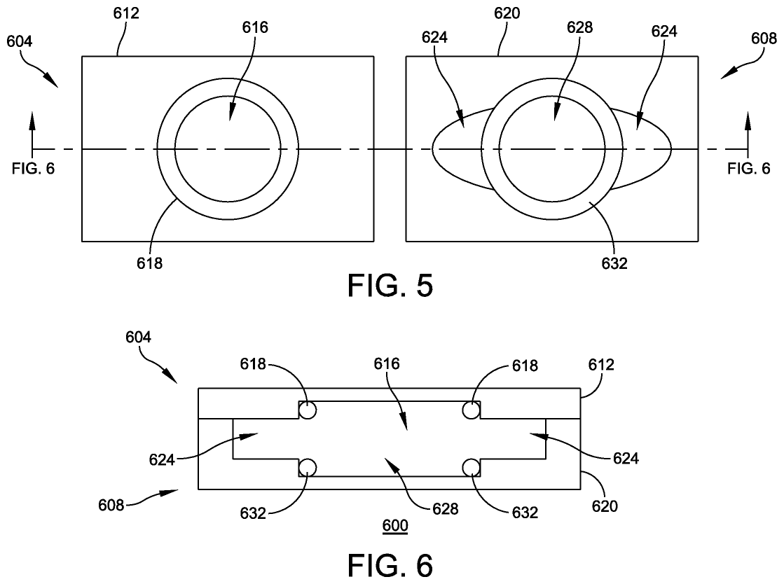

Various other configurations of holders are possible, such as the examples shown in FIGS. 5-8. These examples illustrate other configurations that are also suitable for the safe confinement of one or more nanofiber sheets disposed on a substrate.

FIG. 5 illustrates plan views of the components of an example substrate sample holder shown in cross-section in FIG. 6. Concurrent reference to both FIGS. 5 and 6 will facilitate explanation.

The example sample holder 600 includes a first portion 604 and a second portion 608. The first portion 604 includes a first body 612 that defines a chamber 616. The first portion also includes a first spacer 618, such as a gasket, an O-ring (fabricated from, for example, neoprene, rubber, polytetrafluoroethylene), or other compliant structure that is attached to (or in contact with) the first portion 604 within the chamber 616

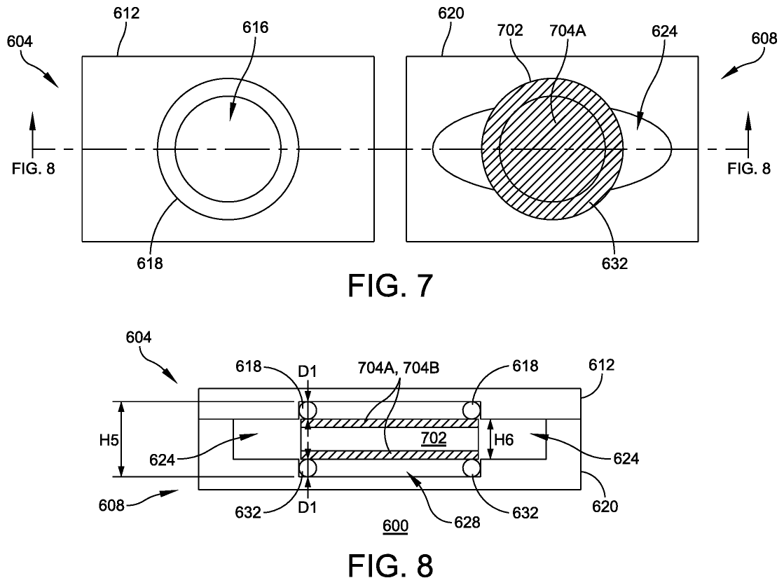

The second portion 608 includes a second body 620 that defines two separate chambers having two different functions: the second chamber 628 and the third chamber 624. These functions will be explained in more detail in the context of FIGS. 7 and 8, described below.

A second spacer 632, analogous to the first spacer 618, is attached to (or in contact with) the second body 620 within the second chamber 628. In some examples, the first body 612, the first spacer 618, the second portion 608, and the second spacer 632 can collectively act as a clamp that secures a nanofiber sheet. The first spacer 618 and the second spacer 632 are shown as circular, and can be embodied by a neoprene, Teflon, or other polymeric O-ring. However it will be appreciated that the first spacer 618 and the second spacer 632 can be any shape or material convenient for the confinement of the substrate on which nanofiber sheets are disposed.

FIGS. 7 and 8 illustrate plan and cross-sectional views, respectively, of the sample holder 600 containing a substrate on which are disposed nanofiber sheets on opposing faces of the substrate. In these views, the sample holder 600 includes a substrate 702 on which are disposed a first nanofiber sheet 704A and a second nanofiber sheet 704B on opposing faces of the substrate 702.

Analogous to the sample holder 100, the sample holder 600 is designed and configured so that the chambers 628 and 616 collectively have a distance H5 that is greater than a distance H5 of the nanofiber sheets 704A, 704B and the substrate 702 on which they are disposed. Furthermore, the distance H5 of the chambers 628 and 616 is dimensioned and configured to include a first diameter D1 of the first spacer 618 and the second spacer 632. In some examples, the distance H5 can have values within any of the following ranges: 0.2 mm to 12 mm; 2 mm to 22 mm; 2 mm to 15 mm; 10 mm to 25 mm: 2 mm to 8 mm: 6 mm to 15 mm; 0.2 mm to 4 mm; 0.5 mm to 3 mm. In some examples, the distance H6 can have values within any of the following ranges: 0.2 mm to 10 mm; 2 mm to 20 mm: 2 mm to 10 mm; 10 mm to 20 mm; 2 mm to 6 mm; 6 mm to 10 mm: 0.2 mm to 2 mm: 0.5 mm to 1 mm. The diameter D1 of the spacers is at least great enough to accommodate any natural elasticity and/or flexure of the substrate 702 so that upon any movement of the substrate 702 the attached nanofiber sheet 704A and 704B will not contact interior surfaces of the first body 612 or the second body 620. In some examples, the diameter D1 can be within any of the following ranges: 0.5 mm to 5 mm; 1 mm to 5 mm; 2 mm to 10 mm; 1 mm to 3 mm, 5 mm to 10 mm; 7 mm to 10 mm. Furthermore, the sample holder 600 can include a conductive layer as described above in the context of FIG. 1.

The third chamber 624, which can be instantiated in any of the holders described herein, provides space into which a tool can be inserted to remove a nanofiber sheet 704A, 704B and or the substrate 702 on which nanofiber sheets 704A, 704B is disposed. For example, after removing the first portion 604, a tip of forceps, tweezer, suction tube, or other tool that can safely grip an individual nanofiber sheet 704A, 704B and/or a substrate 702 on which the nanofiber sheet is disposed can be used to remove the nanofiber sheet and/or the substrate from the holder. Using one or both of the first body 612 and the second body 620 (or analogous bodies for other holders described herein) to define the third chamber 624 thus improves the likelihood that a nanofiber sheet 704A, 704B and or a substrate 702 on which the nanofiber sheet is disposed can be removed conveniently and without damaging the nanofiber sheet. In some examples, a depth of the third chamber 624 corresponds to that of the distance H6. In other examples, a depth of the third chamber 624 is not uniform but gets progressively deeper closer to the spacers 618, 632.

### Holder and Removable Nanofiber Sheet Frame

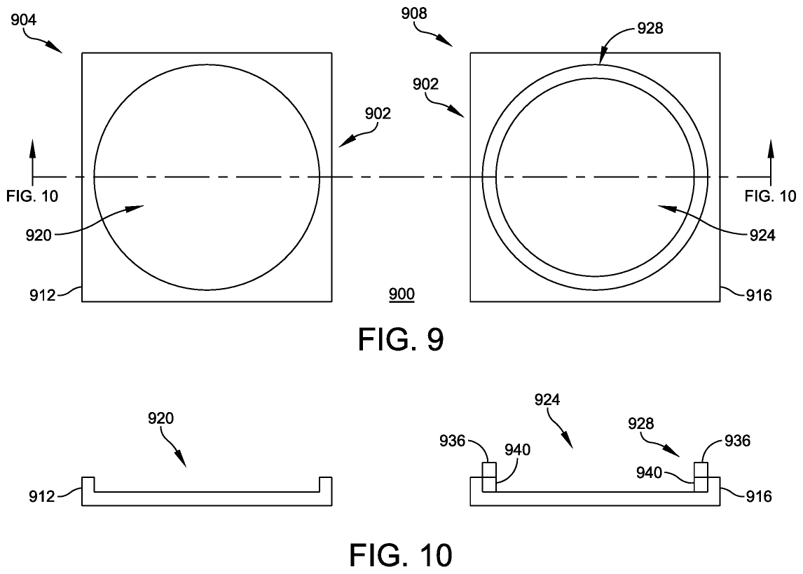

FIGS. 9, 10, 11, 12, and 13A-13D illustrate various views of yet another example embodiment of a nanofiber sheet holder. In the example embodiment shown in these figures, a holder 900 includes an outer housing 902 and a frame 928 configured to fit within the housing.

Analogous to the holders described above, the outer housing 902 of the holder 900 includes a first portion 904 and a second portion 908. The first portion 904 includes a first body 912 that defines a first chamber 920. The second portion 908 includes a second body 916 and defines a second chamber 924. As with the holders described above, the first portion 904 and the second portion 908 are dimensioned and configured to fit together, defining an interior chamber that is the union of the first chamber 920 and the second chamber 924, in which the frame 928 fits. The first body 912 and a second body 916 can be connected, mounted, and/or sealed together so as to protect the nanofiber sheet disposed therein from mechanical perturbation and/or damage.

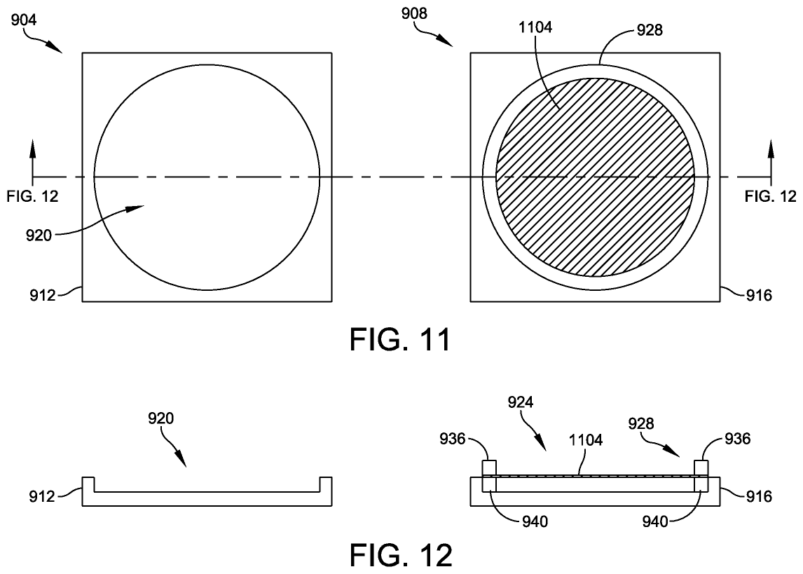

The frame 928, illustrated in cross-section in FIG. 10, includes a first rim 936 and a second rim 940.

FIGS. 11 and 12 show plan view and cross-sectional view, respectively, of the holder 900 containing a nanofiber sheet 1104. For convenience of explanation, FIGS. 11 and 12 illustrate an embodiment in which a freestanding nanofiber sheet 1104 is disposed within the holder 900. However, it will be appreciated that the various elements of the holder 900 can be dimension configured so as to contain one or more nanofiber sheets disposed on the substrate that is held by the frame 928.

FIG. 11 shows, in plan view, the nanofiber sheet 1104 disposed within the frame 928. As shown in the cross-section of FIG. 12, the first rim 936 and the second rim 940 of the frame 928 clamp and stabilize the nanofiber sheet 1104 within the space formed by the chambers 920 and 924. As with the preceding example embodiments, this has the effect of suspending the nanofiber sheet 1104 so as to reduce the likelihood of contact between the nanofiber sheet 1104 and an interior surface of the holder. This also has the effect of maintaining the orientation of the nanofiber sheet 1104 to prevent the sheet from contacting itself or wrinkling.

The holder 900 and the frame 928 can be fabricated from materials already described above in the context of the holders 100 and 600. Furthermore, any of the interior surfaces of the holder 900 or any of the surfaces of the frame 928 can be coated with a conductive material, such as a metal, to reduce the likelihood of electrostatic charge buildup.

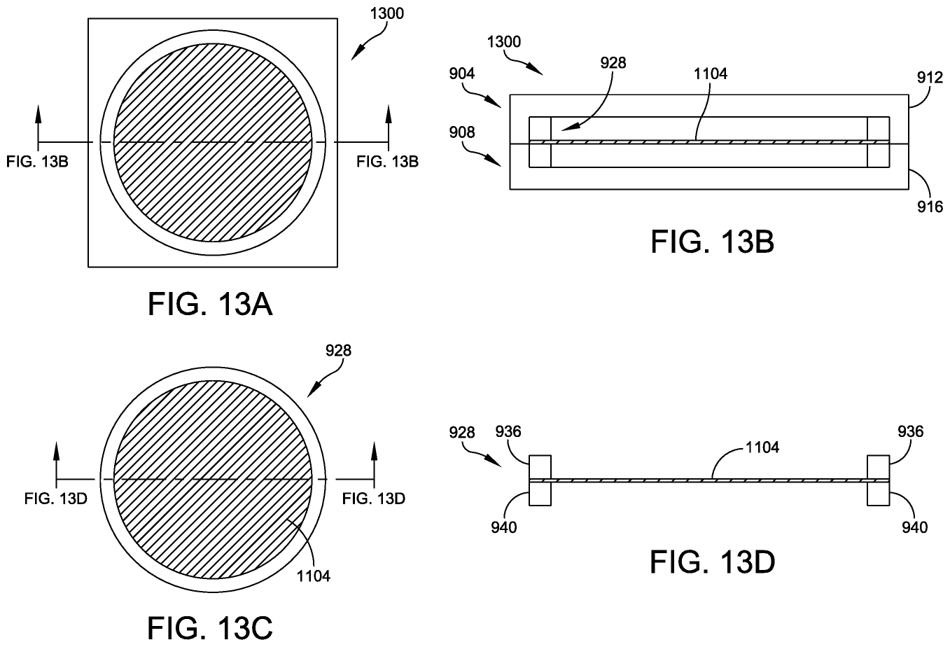

The frame 928 can be partially integrated into the structure of one or more of the portions of the body 904 or 908. For example, the first rim 936 can be integrated with the body 912 and the second rim 940 can be integrated with the body 916. However, this need not be the case as shown in FIGS. 13A-13D. Many of the elements of the holder 1300 are the same as the elements of the holder 900 and need no further description. However, in the example of the holders 1300, the frame 928 is shown in FIGS. 13C and 13D as separable from, and separated from, the first portion 904 and the second portion 908. The ability to remove the frame 928 from other elements of the holder 1300 can improve the convenience with which nanofiber sheets are handled. That is, rather than extricating a nanofiber sheet 1104 from an entire structure of the holder 900, the frame 928 and the associated nanofiber sheet 1104 can be removed. The freestanding portion of the nanofiber sheet 1104 (that is, the portion of the nanofiber sheet 1104 not in contact with elements of the frame 928) can then be examined, tested, or otherwise used without the inconvenience of removing the nanofiber sheet 1104 from the frame. Generally, handling a nanofiber sheet 1104 with in a supporting structure, such as the frame 928, improves the usability and convenience and reduces the likelihood of mechanical damage.

In these embodiments, or indeed any of the embodiments described herein, one method of removing a portion of the nanofiber sheet so that the sheet remains flat and continuous (i.e., not bundled, tom, or adhered to itself) includes passing an excising substrate through the opening defined by the frame (or the clamp). The excising substrate then contacts the freestanding portion of the nanofiber sheet. The nanofiber sheet then can adhere to the substrate and be separated from the peripheral portion of the nanofiber sheet disposed between the elements of the frame or the elements of the clamp (e.g., supports and rim, described above).

### Magnetic Sample Holders

In some examples, a nanofiber sheet treated with a magnetic material can be releasably secured within a holder using a ferromagnet or electromagnet. It will be appreciated that ferromagnetic materials include iron-based magnets, rare earth permanent magnets, among other compositions. While the following description and corresponding figures assume a nanofiber sheet, it will be appreciated that after magnetic material deposition, a nanofiber sheet can be processed into an array of nanofiber bundles separated by gaps or spun into a nanofiber yarn.

An example of a magnetic sample holder is illustrated in FIGS. 14 and 15.

Prior to describing the example magnetic sample holder, a description of techniques for processing nanofiber sheets so as to have a ferromagnetic response follows. It will be appreciated that other forms of nanofibers (e.g., yarns, sheets that include bundles of nanofibers separated by gaps, grids of cross-wise stacked bundled sheets) can be processed using these techniques and releasably secured within a magnetic holder. In some examples, a layer of metal (e.g., iron, copper, zinc, nickel, tungsten, alloys thereof) is deposited on one or both sides of the nanofiber sheet. Deposition techniques include but are not limited to atomic layer deposition (ALD), E-beam deposition, sputtering, among others. In some examples, the layer of metal is from 5 nm to 1 micron thick. While this layer of metal is not necessary, it can be used to improve adhesion for a subsequently deposited layer of magnetic material.

A layer of a ferromagnetic material (e.g., iron, cobalt, nickel, gadolinium) is deposited on one or both sides of the nanofiber sheet (or on some or all of the surface of a nanofiber yarn or bundles of nanofibers) either on the layer of metal or directly on one or both sides of the nanofiber sheet. The layer of the ferromagnetic material can be deposited using ALD, E-beam deposition, sputtering, among other techniques. The layer of the ferromagnetic material can be, for example, between 10 nm and 1 μm thick. The material can be evenly deposited over the entire nanofiber sheet or can be deposited on a portion of the sheet, for instance in a pattern such as a ring, a circle, a square, a grid, a series of stripes or a polka dot pattern.

In other examples, rather than the depositing the layer of magnetic material as described above, magnetic particles can be infiltrated into the nanofiber sheet (or nanofiber yarn, or bundles of nanofibers separated by gaps) via a magnetic particle/solvent suspension. Infiltration of magnetic particles can be accomplished by, for example, suspending magnetic microparticles and/or nanoparticles in a solvent and exposing the nanofiber sheet to the suspension. The magnetic particles can penetrate into the nanofiber sheet by the infiltration of the solvent. The magnetic particles can then be used to secure a nanofiber sheet within a holder, as described below. In still other examples, a magnetic material can be deposited on (or into) a nanofiber sheet, yarn, or bundles, by an electrochemical deposition process, or injection of a magnetic particle suspension into the nanofiber sheet.

It will be appreciated that for a material with a given magnetic moment per unit volume, the less material (i.e., the thinner the layer) deposited on the nanofiber sheet, the lower the ferromagnetic response will be when exposed to a ferromagnet (or electromagnet) within a holder. With this appreciation, the thickness of the layer can be selected in light of the magnetic field strength of the magnet to be included in the holder.

A nanofiber sheet processed, in one example, as described above may then be releasably secured (whether on a substrate or not) within a holder 1400, as shown in FIGS. 14 and 15. The holder 1400 includes many elements described above in other embodiments, which include housing first portion 1404 and housing second portion 1408. The first portion 1404 includes a first body 1412 that defines a first chamber 1420. The second portion 1408 includes a second body 1416 and defines a second chamber 1424. As with the holders described above, the first portion 1404 and the second portion 1408 are dimensioned and configured to fit together, defining an interior chamber that is the union of the first chamber 1420 and the second chamber 1424. The first body 1412 and a second body 1416 can be connected, mounted, and/or sealed together so as to protect the nanofiber sheet disposed therein from mechanical perturbation and/or damage. It will be appreciated that other elements of other examples holders described above may be included in the holder 1400.

In addition to the components of the holder 1400 described above (and those in other examples holders described herein that may be used within the holder 1400) is a magnet 1428 and an optional frame 1432. The magnet 1428 can be fabricated from a ferromagnetic material or an alloy of ferromagnetic materials. A nanofiber sheet that includes the layer of magnetic material described above can then be placed directly on the magnet 1428 or on a substrate (not shown) through which the magnetic field lines can pass (e.g., glass, glass ceramic, polymer, release sheet). This has the effect of releasably securing the nanofiber sheet within the holder 1400, and more specifically within the chamber caused by the union of the first chamber 1420 and the second chamber 1424.

While one magnet 1428 is shown in the example holder 1400, it will be appreciated that multiple smaller magnets may be distributed throughout the chamber 1424 in some embodiments. Furthermore, the magnet 1428 can be dimensioned and configured to be coextensive with the second chamber 1424 or have a diameter or size that is less than that shown in FIG. 14. The shape, number, and size of the magnet 1428 (or magnets) can be determined based on the magnetic strength of the magnetic material, the magnetic response of the nanofiber sheet, the form factor of the nanofiber material (e.g., a sheet versus, one or more nanofiber yarns, versus a sheet comprising bundles of nanofibers separated by gaps). For example, the magnet can be circular, rectangular, a cylindrical ring, a series of bars, or a grid. Similarly the height of the magnet 1428 may also be selected based on one or more of these various factors.

In the example shown in FIG. 15, an optional frame 1432 may also be disposed within the chamber 1424. The optional frame can be magnetic or non-magnetic. This optional frame 1432 can be dimensioned and configured so as to support a portion of the nanofiber sheet (not shown) not supported by the magnet 1428, or in the absence of magnet 1428. For example, if a size of the magnet 1428 was significantly smaller than the size of the chamber 1424 and a size of a nanofiber sheet, the frame 1432 can be dimensioned and configured to support a portion of the nanofiber sheet not directly supported by the magnet 1428. In this way, the magnet 1428 can still secure the nanofiber sheet within the holder 1400 via exertion of the magnetic force, and the edges or portions of the nanofiber sheet not physically supported by the magnet are supported by the frame 1432.

Use of the magnet can help to reduce movement of the nanofiber sheet within the holder 1400 during movement/shipment and even during processing. Furthermore, a magnetized nanofiber sheet can be removed from the holder 1400 by using a stronger magnet separate from the magnet 1428. Unlike an adhesive, a magnet leaves no residue and need not come into actual contact with the nanofiber sheet. Electromagnets can be magnetized and demagnetized, meaning that the magnetic field can be released without applying any mechanical force to either the holder or the nanofiber sheet. This can help to retain the structure of delicate nanofiber compositions.

### Nanofiber Forests

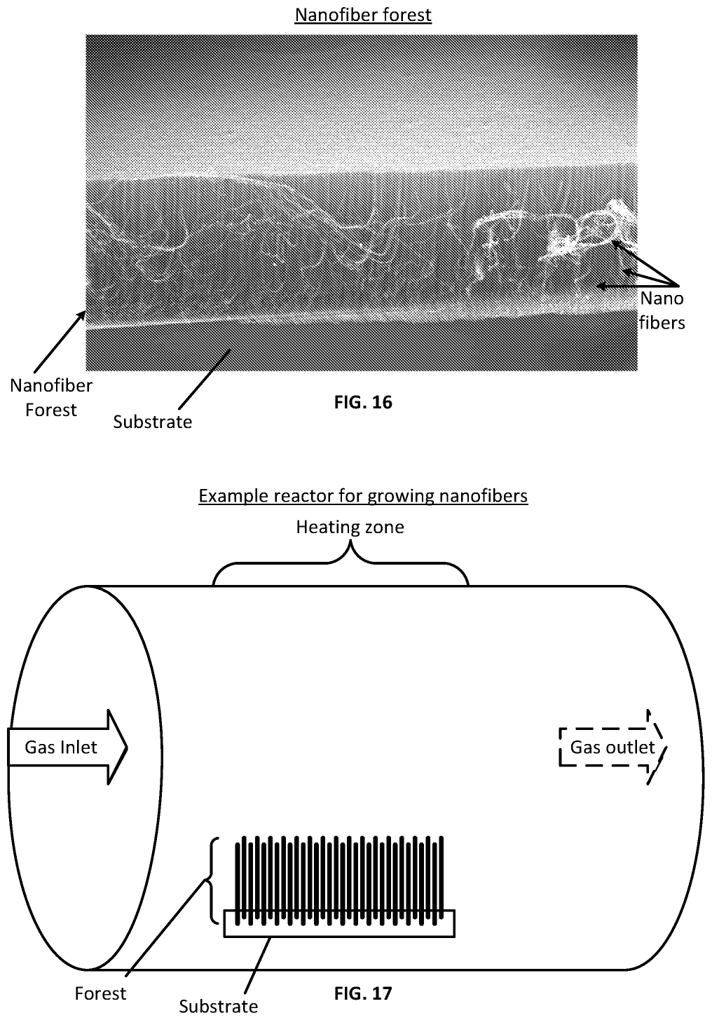

As used herein, the term “nanofiber” means a fiber having a diameter less than 1 μm. While the embodiments herein are primarily described as fabricated from carbon nanotubes, it will be appreciated that other carbon allotropes, whether graphene, micron or nano-scale graphite fibers and/or plates, and even other compositions of nano-scale fibers such as boron nitride may be densified using the techniques described below. As used herein, the terms “nanofiber” and “carbon nanotube” encompass both single walled carbon nanotubes and/or multi-walled carbon nanotubes in which carbon atoms are linked together to form a cylindrical structure. In some embodiments, carbon nanotubes as referenced herein have between 4 and 10 walls. As used herein, a “nanofiber sheet” or simply “sheet” refers to a sheet of nanofibers aligned via a drawing process (as described in PCT Publication No. WO 2007/015710, and incorporated by reference herein in its entirety) so that a longitudinal axis of a nanofiber of the sheet is parallel to a major surface of the sheet, rather than perpendicular to the major surface of the sheet (i.e., in the as-deposited form of the sheet, often referred to as a “forest”). This is illustrated and shown in FIGS. 16 and 17, respectively.

The dimensions of carbon nanotubes can vary greatly depending on production methods used. For example, the diameter of a carbon nanotube may be from 0.4 nm to 100 nm and its length may range from 10 μm to greater than 55.5 cm. Carbon nanotubes are also capable of having very high aspect ratios (ratio of length to diameter) with some as high as 132,000.000:1 or more. Given the wide range of dimensional possibilities, the properties of carbon nanotubes are highly adjustable, or “tunable.” While many intriguing properties of carbon nanotubes have been identified, harnessing the properties of carbon nanotubes in practical applications requires scalable and controllable production methods that allow the features of the carbon nanotubes to be maintained or enhanced.

Due to their unique structure, carbon nanotubes possess particular mechanical, electrical, chemical, thermal and optical properties that make them well-suited for certain applications. In particular, carbon nanotubes exhibit superior electrical conductivity, high mechanical strength, good thermal stability and are also hydrophobic. In addition to these properties, carbon nanotubes may also exhibit useful optical properties. For example, carbon nanotubes may be used in light-emitting diodes (LEDs) and photo-detectors to emit or detect light at narrowly selected wavelengths. Carbon nanotubes may also prove useful for photon transport and/or phonon transport.

In accordance with various embodiments of the subject disclosure, nanofibers (including but not limited to carbon nanotubes) can be arranged in various configurations, including in a configuration referred to herein as a “forest.” As used herein, a “forest” of nanofibers or carbon nanotubes refers to an array of nanofibers having approximately equivalent dimensions that are arranged substantially parallel to one another on a substrate. FIG. 16 shows an example forest of nanofibers on a substrate. The substrate may be any shape but in some embodiments the substrate has a planar surface on which the forest is assembled. As can be seen in FIG. 16, the nanofibers in the forest may be approximately equal in height and/or diameter.

Nanofiber forests as disclosed herein may be relatively dense. Specifically, the disclosed nanofiber forests may have a density of at least 1 billion nanofibers/cm2. In some specific embodiments, a nanofiber forest as described herein may have a density of between 10 billion/cm2 and 30 billion/cm2. In other examples, the nanofiber forest as described herein may have a density in the range of 90 billion nanofibers/cm2. The forest may include areas of high density or low density and specific areas may be void of nanofibers. The nanofibers within a forest may also exhibit inter-fiber connectivity. For example, neighboring nanofibers within a nanofiber forest may be attracted to one another by van der Waals forces. Regardless, a density of nanofibers within a forest can be increased by applying techniques described herein.

Methods of fabricating a nanofiber forest are described in, for example, PCT No. WO2007/015710, which is incorporated herein by reference in its entirety.

Various methods can be used to produce nanofiber precursor forests. For example, in some embodiments nanofibers may be grown in a high-temperature furnace, schematically illustrated in FIG. 17. In some embodiments, catalyst may be deposited on a substrate, placed in a reactor and then may be exposed to a fuel compound that is supplied to the reactor. Substrates can withstand temperatures of greater than 800° C. or even 1000° C. and may be inert materials. The substrate may comprise stainless steel or aluminum disposed on an underlying silicon (Si) wafer, although other ceramic substrates may be used in place of the Si wafer (e.g., alumina, zirconia. SiO2, glass ceramics). In examples where the nanofibers of the precursor forest are carbon nanotubes, carbon-based compounds, such as acetylene may be used as fuel compounds. After being introduced to the reactor, the fuel compound(s) may then begin to accumulate on the catalyst and may assemble by growing upward from the substrate to form a forest of nanofibers. The reactor also may include a gas inlet where fuel compound(s) and carrier gasses may be supplied to the reactor and a gas outlet where expended fuel compounds and carrier gases may be released from the reactor. Examples of carrier gases include hydrogen, argon, and helium. These gases, in particular hydrogen, may also be introduced to the reactor to facilitate growth of the nanofiber forest. Additionally, dopants to be incorporated in the nanofibers may be added to the gas stream.

In a process used to fabricate a multilayered nanofiber forest, one nanofiber forest is formed on a substrate followed by the growth of a second nanofiber forest in contact with the first nanofiber forest. Multi-layered nanofiber forests can be formed by numerous suitable methods, such as by forming a first nanofiber forest on the substrate, depositing catalyst on the first nanofiber forest and then introducing additional fuel compound to the reactor to encourage growth of a second nanofiber forest from the catalyst positioned on the first nanofiber forest. Depending on the growth methodology applied, the type of catalyst, and the location of the catalyst, the second nanofiber layer may either grow on top of the first nanofiber layer or, after refreshing the catalyst, for example with hydrogen gas, grow directly on the substrate thus growing under the first nanofiber layer. Regardless, the second nanofiber forest can be aligned approximately end-to-end with the nanofibers of the first nanofiber forest although there is a readily detectable interface between the first and second forest. Multi-layered nanofiber forests may include any number of forests. For example, a multi-layered precursor forest may include two, three, four, five or more forests.

### Nanofiber Sheets

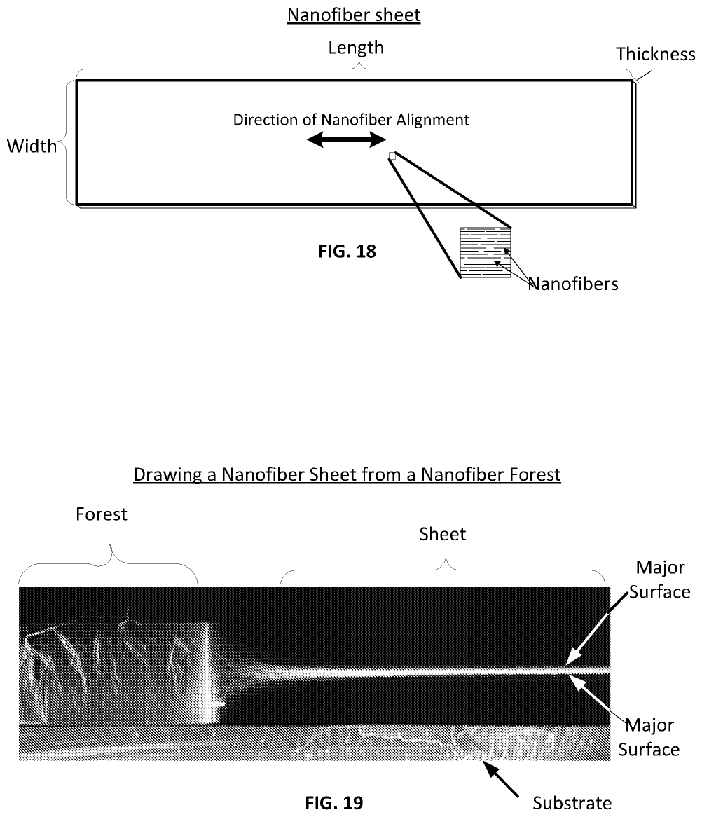

In addition to arrangement in a forest configuration, the nanofibers of the subject application may also be arranged in a sheet configuration. As used herein, the term “nanofiber sheet,” “nanotube sheet,” or simply “sheet” refers to an arrangement of nanofibers where the nanofibers are aligned end to end in a plane. An illustration of an example nanofiber sheet is shown in FIG. 18 with labels of the dimensions. In some embodiments, the sheet has a length and/or width that is more than 100 times greater than the thickness of the sheet. In some embodiments, the length, width or both, are more than 10³, 10⁶ or 10⁹ times greater than the average thickness of the sheet. A nanofiber sheet can have a thickness of, for example, between approximately 5 nm and 30 μm and any length and width that are suitable for the intended application. In some embodiments, a nanofiber sheet may have a length of between 1 cm and 10 meters and a width between 1 cm and 1 meter. These lengths are provided merely for illustration. The length and width of a nanofiber sheet are constrained by the configuration of the manufacturing equipment and not by the physical or chemical properties of any of the nanotubes, forest, or nanofiber sheet. For example, continuous processes can produce sheets of any length. These sheets can be wound onto a roll as they are produced.

As can be seen in FIG. 18, the axis in which the nanofibers are aligned end-to end is referred to as the direction of nanofiber alignment. In some embodiments, the direction of nanofiber alignment may be continuous throughout an entire nanofiber sheet. Nanofibers are not necessarily perfectly parallel to each other and it is understood that the direction ofnanofiber alignment is an average or general measure of the direction of alignment of the nanofibers.

Nanofiber sheets may be assembled using any type of suitable process capable of producing the sheet. In some example embodiments, nanofiber sheets may be drawn from a nanofiber forest. An example of a nanofiber sheet being drawn from a nanofiber forest is shown in FIG. 19.

As can be seen in FIG. 19, the nanofibers may be drawn laterally from the forest and then align end-to-end to form a nanofiber sheet. In embodiments where a nanofiber sheet is drawn from a nanofiber forest, the dimensions of the forest may be controlled to form a nanofiber sheet having particular dimensions. For example, the width of the nanofiber sheet may be approximately equal to the width of the nanofiber forest from which the sheet was drawn. Additionally, the length of the sheet can be controlled, for example, by concluding the draw process when the desired sheet length has been achieved.

Nanofiber sheets have many properties that can be exploited for various applications. For example, nanofiber sheets may have tunable opacity, high mechanical strength and flexibility, thermal and electrical conductivity, and may also exhibit hydrophobicity. Given the high degree of alignment of the nanofibers within a sheet, a nanofiber sheet may be extremely thin. In some examples, a nanofiber sheet is on the order of approximately 10 nm thick (as measured within normal measurement tolerances), rendering it nearly two-dimensional. In other examples, the thickness of a nanofiber sheet can be as high as 200 nm or 300 nm. As such, nanofiber sheets may add minimal additional thickness to a component.

As with nanofiber forests, the nanofibers in a nanofibers sheet may be functionalized by a treatment agent by adding chemical groups or elements to a surface of the nanofibers of the sheet and that provide a different chemical activity than the nanofibers alone. Functionalization of a nanofiber sheet can be performed on previously functionalized nanofibers or can be performed on previously unfunctionalized nanofibers. Functionalization can be performed using any of the techniques described herein including, but not limited to CVD, and various doping techniques.

Nanofiber sheets, as drawn from a nanofiber forest, may also have high purity, wherein more than 90%, more than 95% or more than 99% of the weight percent of the nanofiber sheet is attributable to nanofibers, in some instances. Similarly, the nanofiber sheet may comprise more than 90%, more than 95%, more than 99% or more than 99.9% by weight of carbon.

### FURTHER CONSIDERATIONS

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

What is claimed is:

1. A nanofiber sheet holder comprising:
a first portion comprising:
a first body, an interior surface of the first body defining a first chamber;
a rim on the interior surface of the first body, the rim proximate to at least a portion of a perimeter of the first chamber:
a second portion comprising:
a second body, an interior surface of the second body defining a second chamber;
a support on the interior surface of the second body, the support proximate to at least a portion of a perimeter of the second chamber;
a nanofiber sheet in contact with at least one of the rim of the first portion and the support of the second portion;
wherein:
the first portion and the second portion are configured to mount together at a joint; and
the rim and the support are configured to align with each other when the first portion and the second portion are mounted together, thus clamping a peripheral edge of the nanofiber sheet therebetween.

2. The nanofiber sheet holder of claim 1, further comprising a conductive layer on at least one of the interior surface of the first body, the interior surface of the second body, the rim, and the support.

3. The nanofiber sheet holder of claim 1, wherein the rim and the support are configured to contact one another without the nanofiber sheet therebetween when the first portion and the second portion are mounted together.

4. The nanofiber sheet holder of claim 3, wherein contact between the rim and the support without the nanofiber sheet therebetween comprises an interference fit.

5. The nanofiber sheet holder of claim 3, further comprising a freestanding portion of the nanofiber sheet within the peripheral edge, the freestanding portion supporting its own weight within the nanofiber sheet holder when the peripheral edge is clamped between the rim and the support.

6. The nanofiber sheet holder of claim 5, wherein the first chamber and the second chamber form a combined chamber when the first portion and the second portion are mounted together, the freestanding portion of the nanofiber sheet disposed within the combined chamber.

7. The nanofiber sheet holder of claim 1, wherein the rim and the support are integral with the first portion and the second portion, respectively.

8. The nanofiber sheet holder of claim 1, wherein the rim and the support are continuous around the perimeter of the first chamber and the perimeter of the second chamber, respectively.

9. The nanofiber sheet holder of claim 8, wherein the rim and the support together comprise a removable frame that can be removed from at least one of the first body and the second body.

10. The nanofiber sheet holder of claim 9, further comprising a freestanding portion of the nanofiber sheet within the peripheral edge, the freestanding portion supporting its own weight within the nanofiber sheet holder when the peripheral edge is clamped between the rim and the support.

11. The nanofiber sheet holder of claim 10, wherein the removable frame and the nanofiber sheet are removable as a unit from the first portion and the second portion.

12. The nanofiber sheet holder of claim 1, further comprising a first spacer on the interior surface of the first body, the first spacer proximate to at least a portion of a perimeter of the first chamber and a second spacer on the interior surface of the second body, the second spacer proximate to at least a portion of a perimeter of the second chamber, wherein the first spacer and the second spacer are O-rings.

13. A nanofiber sheet holder comprising:
a first portion comprising a first body, an interior surface of the first body defining a first chamber;
a second portion comprising:
a second body, an interior surface of the second body defining a second chamber;
a magnet connected to the interior surface of the second body within the second chamber; and
a nanofiber sheet on the magnet, the nanofiber sheet comprising a magnetic material, wherein the first portion and the second portion are configured to mount together at a joint.

14. The nanofiber sheet holder of claim 13, wherein the nanofiber sheet further includes a layer of metal between the magnetic material and nanofibers of the nanofiber sheet.

15. The nanofiber sheet holder of claim 13, wherein the magnetic material on the nanofiber sheet is iron.

16. The nanofiber sheet holder of claim 13, further comprising a substrate between the nanofiber sheet and the magnet.

17. The nanofiber sheet holder of claim 13, further comprising a frame within the second chamber configured to support at least a portion of the nanofiber sheet on the magnet.

18. A method for securing a nanofiber sheet comprising:
clamping a nanofiber sheet between a first portion of a clamp and a second portion of the clamp by placing a first portion and a second portion in contact with at least some of a peripheral edge of the nanofiber sheet; and
enclosing the nanofiber sheet, the first portion of the clamp, and the second portion of the clamp within a nanofiber sheet holder, the nanofiber sheet holder separating the nanofiber sheet from an environment surrounding the nanofiber sheet holder,
wherein a freestanding portion of the nanofiber sheet not positioned between the first portion and second portion is suspended within a chamber defined by an interior surface of the nanofiber sheet holder.

19. The method of claim 18, wherein:
the first portion and the second portion of the clamp are integral with the nanofiber sheet holder; and
clamping the nanofiber sheet includes contemporaneously enclosing the nanofiber sheet within the nanofiber sheet holder.

20. The method of claim 18, further comprising electrically grounding an interior of the nanofiber sheet holder via a conductive layer disposed on the interior surface of the nanofiber sheet holder.
